(19) United States
(12) Patent Application Publication
(10) Pub. No.: US 2018/0096421 A1
(43) Pub. Date: Apr. 5, 2018

(54) AUTOMATIC CLUB MEMBERSHIP

(71) Applicant: Wal-Mart Stores, Inc., Bentonville, AR (US)

(72) Inventors: Jimmie R. Clark, Fayetteville, AR (US); Michael Lawerance Payne, Centerton, AR (US); Jeffrey L. Stone, Bentonville, AR (US)

(21) Appl. No.: 15/690,833

(22) Filed: Aug. 30, 2017

Related U.S. Application Data
(60) Provisional application No. 62/401,950, filed on Sep. 30, 2016.

(51) Int. Cl. G06Q 40/00; G06Q 20/20; G06K 7/14

(52) U.S. Cl. CPC G06Q 40/00; G06K 7/1413; G06K 7/1417; G06Q 20/204

(57) ABSTRACT

A system is described to reduce the number of customers waiting in line at a customer service desk of a club membership store. When a customer walks into the store, an App is activated by scanning a visual pattern, such as a QR code, responding to prompts sent via Wi-Fi, or using near field communication (NFC). The App connects the customer's mobile device to a remote computing device. The App reduces the information the customer has to type by scanning for a contact card prestored on the customer's mobile computing device. Using the contact card information, the remote computing device can check the customer's membership status. If the customer is not a member it can push membership promotions to the mobile computing device. The membership fee will be added to the charges for items purchased to result in a single checkout.

### RELATED APPLICATIONS

This application claims the benefit of U.S. Provisional Patent No. 62/401,950, filed Sep. 30, 2016, entitled “Automatic Club Membership,” the contents of which are incorporated by reference herein in their entirety.

### FIELD

Aspects of the present invention relate to a system for automatically updating purchasing club memberships, and more specifically to a system for automatically updating purchasing club memberships that adjusts product costs based upon membership status.

### BACKGROUND

There are group purchasing clubs which are open to the public for a nominal membership fee. This membership fee allows the club to sell products at a reduced price to its members. Also, products are sold in volume to further reduce the price.

Active members benefit from the reduced prices. However, some people are reluctant to join the membership without being familiar with the products being offered. In this case the club allows nonmembers to shop, but charges them increased sale prices.

The membership is typically periodic and must be renewed to keep the membership active. The renewal fee must be paid when the membership is renewed. Typically, the member goes to the customer service desk of the club to renew the membership. This requires identification of the member and then payment for the membership. Since the member will later pay for products that he/she purchases, he/she will have to go through the checkout process twice.

Those starting as new members must provide physical identification information, which takes additional time.

There are new offerings and upgrades that the club offers; however, members typically do not know of these offerings or upgrades. Members may be interested in these; however, it is difficult to notify them. Typically, this is done at the customer service desk when the membership is being renewed.

Since the customer service desks handle a number of tasks besides renewal of memberships, there can be long lines of customers waiting to handle other matters. This is especially a problem during peak shopping seasons. Since the customer service desk is accepting information to look up members, accepting payments for memberships, verifying the identity of new members with physical means, providing information as to offers and upgrades as well as performing their normal talks, the customer service desk can become backed up with long lines of customers waiting to be helped. The long wait can be frustrating to members.

Currently, there is a need for a system which can automatically identify existing members, provide information of the current offerings and upgrades available to a member, renew membership, add new members electronically, and handle payment of the renewal fee along with the payment of other items purchased.

### BRIEF SUMMARY

According to aspects of the present inventive concepts there is provided an apparatus and method as set forth in the appended claims. Other features of the inventive concepts will be apparent from the dependent claims, and the description which follows.

One embodiment of the current invention may be described as a method of updating membership status of a customer entering a club by causing the mobile device to contact a remote computing entity that adjusts membership status, searching the customer's mobile device for a contact card, interacting with the customer through the mobile device to create a contact card, if one was not found, and interacting with the customer to update a contact card if one was found, using information on the contact card to search a membership database to acquire membership status of the customer.

If the membership status indicates that a membership does not exist for this customer, then the method requires interacting with the customer to create a membership. If the membership status indicates that a current membership will expire soon then the method requires interacting with the customer to renew the membership, and upgrade the membership, if the membership status indicates that a current membership and customer chooses an upgrade. The information and membership status is then stored in the membership database and sent to a point of sale (POS) device.

The cost of goods purchased by the customer at a point of sale device are adjusted based upon the customer's current membership status; and any membership and upgrade charges are added at the point of sale device.

The invention of the current application may also be embodied as a club membership system adapted to update membership status having a mobile device. The mobile device includes a contact information module adapted to interact with the customer, a linking module adapted to automatically make a connection to a specific remote computing entity, a mobile controller adapted to display screens with choices to a customer and receive the customer selections, and a payment module adapted to make an electronic payment. The club membership system also includes a membership database having the current status of each membership and a remote computing entity, connected to the linking module. The remote entity includes a search module in communication with the contact information module and the membership database. The remote entity is adapted to receive the contact card form the mobile device and search the membership database and find a membership and its status related to a contact card.

The remote entity also includes a base controller coupled to the mobile controller for interactively providing screens requesting customer input to the mobile controller to display to the customer, and for receiving the customer's input in response to the screens.

The remote entity also includes an update module in communication with mobile controller and the membership database for receiving customer input and updating the membership database based upon the customer input.

A point of sale (POS) device is coupled to the base controller and the payment module. The POS device is adapted to receive membership status and adjust costs based upon the membership status, add charges for any membership payments and upgrades, and receive payment from the customer through the payment module.

The current invention may also be embodied as a club membership system adapted to update membership status via a mobile device running an App that automatically makes a connection to a specific remote computing entity, displays screens to a customer and receives the customer selections. It also has the ability to make electronic payments.

The club membership system also includes a membership database having the current status of each membership, and a remote computing entity connected to the linking module that is adapted to receive the contact card and search the membership database and find a membership and its status related to a contact card. The remote computing entity can provide screens requesting customer input and receive the customer's input in response to the screens, input and update the membership database with the customer input. It also includes a point of sale (POS) device adapted to receive membership status, add an upcharge for non-members, add charges for any membership fees and upgrade fees, and receive payment from the customer.

Customers are notified of the advantages of being a member. Also non-members are notified how much could have been saved on the cost of goods purchased if they had been a member.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 is a block diagram showing the main elements of a club membership system in accordance with one embodiment of the present invention.

FIG. 2 is a flowchart that illustrates the functioning of club membership system of claim 1 for existing members.

FIG. 3 is a flowchart that illustrates the functioning of club membership system of claim 1 for new members.

### DETAILED DESCRIPTION

### Theory

One goal of the current invention is to reduce the amount of work done by the employees at the customer service desk to reduce the lines waiting for service. The customer will not have to stand in line as long and it may possibly free up the associates to process other types of requests.

This is done by allowing the customers to process new memberships, renew, and/or upgrade existing memberships and receive promotions using their mobile devices. This allows many new members to register nearly simultaneously without joining the membership queue.

New members will not need to supply physical proof of identification since the transactions will be done on the customer's mobile device.

Customers will only pay once and not have to pay for the membership fee separately, then pay for the products that they purchase. This reduces redundancy and streamlines the process.

### Implementation

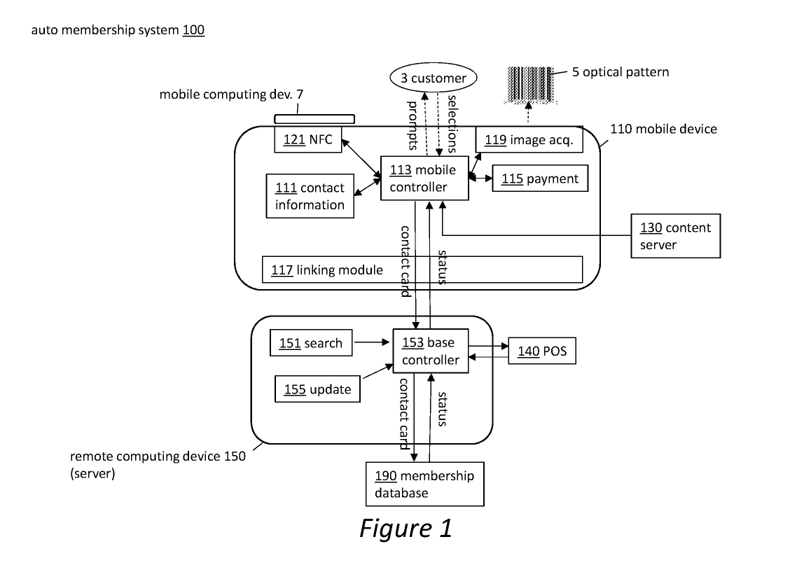

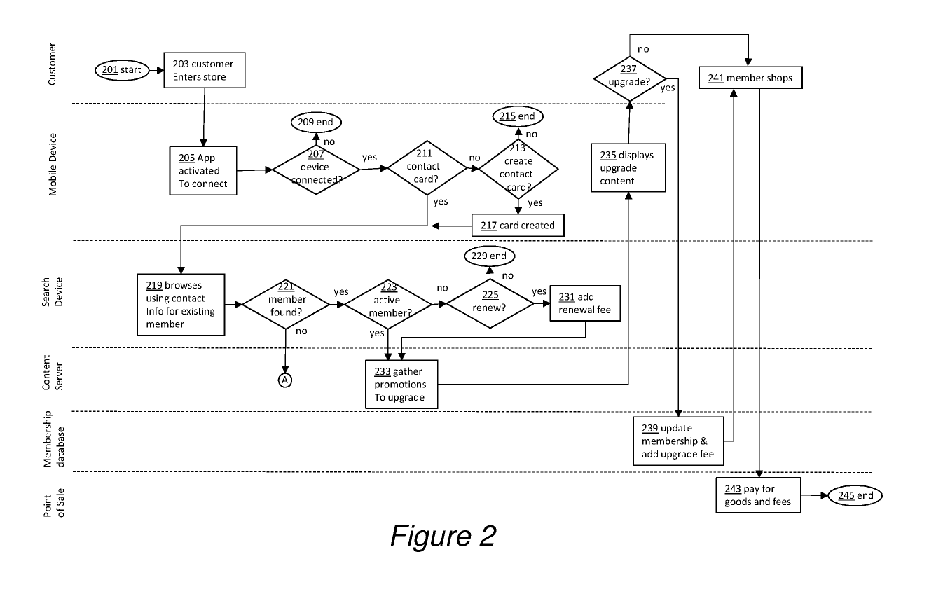

The structure and functioning of the current invention will be described in connection with FIGS. 1 and 2. In step 201 the process starts. In step 203 the customer 3 enters a store.

In step 205, a small executable program (“App”) is activated in the customer's mobile device 110. This mobile device 110 may be a smart phone, computing tablet, or other mobile device used by the customer for computing.

The App may be initiated by scanning a bar code, QR code or other optical pattern 5 with an image acquisition device 119 that causes the mobile device 110 to link to a specific remote computing device, such as a server 150 shown in FIG. 1. For example, there may be a poster on the wall with a QR code indicating that the customer 3 gets a discount for certain products if they scan the QR code which allows the system to automatically check their membership status.

Alternatively, mobile device 110 may employ a near field communication (“NFC”) sensor 121 which can inductively send signals to and receive signals from another mobile device 7 also having NFC capabilities that is placed against it. Mobile device 110 can therefore receive data and instructions that it executes to link it to server 150.

This may be implemented by a greeter which indicates that if they allow the greeter to place his/her phone next to their phone, it will automatically check their membership status and give them a discount on certain products.

In another alternative embodiment, a program is already running on mobile device 110 as customer 3 nears and enters the store. This may be an App which is intentionally activated, such as the Walmart App that provide information on the store and special offers.

It may also be a routine which runs in the background and only becomes active when it senses when the mobile device 110 is near or within a specific store. It may use GPS or other location determination systems to identify when it is within a specified range of a specific store. At this point it then links to server 150.

Mobile device 110 employs a linking device 117 to make the communication link to server 150, content server 130, point-of-sale (POS) device 140 and/or a membership database 190. Mobile device 110 may use a number of conventional communications systems to make this link, such as cellular phone communication, Wi-Fi communication, or other conventional communication means.

In step 207, it is determined if mobile device 110 is connected to server 150. If there is no connection, the process ends at step 209.

If in step 207 it was determined that there is a connection with server 150 (“yes), then contact information element 111 searches mobile device 110 to find a prestored contact card having information about the customer 3. Contact information element 111, like the other elements described in this application, may be embodied as an active element which is capable of performing its described functions, or as executable code which is run on an active computing device, such as mobile controller 113.

In step 211 if the contact card is not found on mobile device 110 (“no”), then in step 213 the customer is asked if they would like to create a new contact card. If the customer would not like to create a new one (“no”), then the process ends in step 215. If the customer does want to create a new contact card (“yes”), then in step 217 mobile device 110 interacts with customer 3 to receive information that is stored on mobile device 110 as a contact card. This information passes from customer 3 through mobile controller 113 that updates information stored in contact information 111.

In step 211, if the contact card is found, it is sent to base controller 153 of server 150.

In step 219, a search element 151 searches the membership database 190 using the information from the contact card. This may be embodied as an active element communicating with the membership database 190 through base controller 153, or as executable code which is executed by base controller 153.

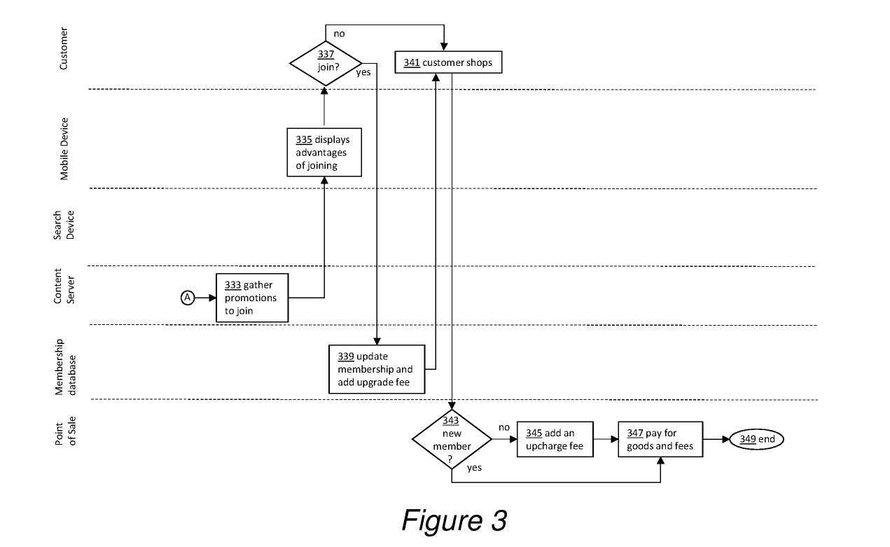

In step 221 is determined if the member has been found and if not the steps of FIG. 3 are performed starting at “A”.

In step 221, if a member has been found then it is determined in step 223 if the member is an active member. If the member is an active member (“yes”) processing continues at step 233.

If, in step 223 it was determined that the member found is not an active member, the member is requested to renew his/her membership in step 225.

If in step 225, the customer does not choose to renew their membership the process ends at step 229.

If the customer chooses to renew their membership in step 225 (‘yes”), a renewal fee is added to the amount owed by the customer, now an active member.

In step 233 content server 130 gathers promotional materials showing the benefits of upgrading to a higher membership. These promotional materials are sent to mobile device 110 to display to customer 3 in step 235.

In step 237 the customer 3 is asked if they want to upgrade their membership. If the customer 3 agrees to upgrade his/her membership (“yes”), update element 155 of server 150 updates membership status in membership database 190 for customer 3. Update element 155 may be embodied as an active element communicating through base controller 153 with membership database 190, or may be executable code which is run by base controller 153.

In step 241 the member shops in the store and chooses items to purchase. In step 243 the member goes to the point of sale device 140 and pays for the items purchased along with any membership, and upgrade fees.

Customer 3 interacts with a payment element 115 in mobile device 110. Again, payment element 115 may be an active device which communicates through mobile controller 113, linking device 117, and base controller 153 to the POS device 140 to make payment. As indicated above, payment element may be executable code which is run on mobile controller 113 to perform the same functions.

This arrangement thereby allows a single checkout to cover membership fees, upgrade fees, and the cost of goods purchased.

The process ends at step 245.

This flowchart covers customers who were at one time members of the club. FIG. 3 covers those for new members. The structure and functioning of one embodiment of the current invention will be described with reference to FIGS. 1 and 3.

In step 221 of FIG. 2 if a member is not found, processing continues at step 333 of FIG. 3.

In step 333 content server 130 gathers promotions showing the benefits of joining the club. These are provided to mobile device 110.

In step 335, mobile device 110 displays these promotions to customer 3.

In step 337 the customer 3 is asked if he/she would like to join the club. If customer 3 does not want to join the club (“no”) then processing continues at step 341. If customer 3 does want to join the club (“yes”) then processing continues at step 339.

In step 339, base controller 153 of server 150 runs an update routine 155 to update membership database 190 with the current status of customer 3. This also adds the membership fee to the amount that customer 3 owes.

In step 341 the customer shops for items to purchase.

In step 343 it is determined at the point of sale 140 if customer 3 has joined and is a new member. If so (“yes”), then processing continues at step 347.

If customer 3 has not joined (“no”) then in step 345 an upcharge fee is added to each of the items purchased.

In step 347, the customer pays for the goods and any fees in a single step.

The process ends in step 349.

Although a few examples have been shown and described, it will be appreciated by those skilled in the art that various changes and modifications might be made without departing from the scope of the invention, as defined in the appended claims.

What is claimed is:

1. A method of updating membership status of a customer entering a club with a mobile device, comprising the steps of:
causing the mobile device to contact a remote computing entity that adjusts membership status;
searching the customer's mobile device for a contact card;
interacting with the customer through the mobile device to create a contact card if one was not found and interacting with the customer to update a contact card is one was found;
searching a membership database with the contact card to acquire membership status of the customer;
interacting with the customer to create a membership, if the membership status indicates that a membership does not exist for this customer;
interacting with the customer to renew a membership, if the membership status indicates that a current membership will expire soon;
interacting with the customer to upgrade a membership, if the membership status indicates that a current membership exists and customer chooses an upgrade;
storing any changed membership information in the membership database;
sending the current membership status to a point of sale device;
adjusting cost of goods purchased by the customer at a point of sale device based upon the customer's current membership status; and
adding any membership and upgrade charges at the point of sale device.

2. The method of claim 1, wherein the step of adjusting membership status comprises at least one of the steps of:
starting a new club membership;
renewing an existing active club membership; and
reviving an expired club membership.

3. The method of claim 1, wherein the step of causing the mobile device to contact the remote computing entity comprises the step of:
providing an optical pattern to the customer's computing device indicating a website on the remote computing entity; and
reading the optical pattern causing the mobile device to contact the website on the remote computing entity.

4. The method of claim 3 wherein the optical pattern is selected from the group consisting of:
a bar code, QR code, and other optical code associated with the website.

5. The method of claim 1, wherein the step of causing the mobile device to contact the remote computing entity comprises the step of:
placing a computing device that is capable of communicating by ‘Near Field Communication (NFC)’ next to the customer's computing device to transfer an executable file to the customer's computing device; and
activating the executable file causing the mobile device to contact the website on the remote computing entity.

6. The method of claim 1, wherein the step of causing the mobile device to contact the remote computing entity comprises the step of:
providing a Wi-Fi communication device within transmission range of the customer's computing device;
transferring an executable file to the customer's computing device; and
activating the executable file causing the mobile device to contact the website on the remote computing entity.

7. The method of claim 1, further comprising the step of:
displaying membership upgrades to the customer; and
sending the charges to a point of sale device, if the customer accepts an upgrade so that the customer can pay them along with any products purchased;
updating the customer's membership status, if the customer accepts the upgrade.

8. The method of claim 1, further comprising the step of:
sending a renewal fee to the point of sale device, to be added to a cost of any goods purchased by the customer to allow a single payment.

9. The method of claim 1, further comprising the step of:
adding a surcharge on goods purchased, if the customer is not a current member.

10. The method of claim 1, wherein the remote computing entity is a web server.

11. A club membership system adapted to update membership status comprising:
a mobile device comprising:
a contact information module adapted to interact with the customer;
a linking module adapted to automatically make a connection to a specific remote computing entity;
a mobile controller adapted to display screens with choices to a customer and receive the customer selections;
a payment module adapted to make an electronic payment;
a membership database having the current status of each membership;
a remote computing entity, connected to the linking module, comprising:
a search module in communication with the contact information module and to the membership database, adapted to receive the contact card and search the membership database and find a membership and its status related to a contact card;
a base controller coupled to the mobile controller for interactively providing screens requesting customer input to the mobile controller to display to the customer and for receiving the customer's input in response to the screens;
an update module in communication with mobile controller and the membership database for receiving customer input and updating the membership database based upon the customer input; and
a point of sale device coupled to the base controller and the payment module, adapted to receive membership status and adjust costs based upon the membership status, add charges for any membership payments and upgrades; and adapted to receive payment from the customer through the payment module.

12. The club membership system of claim 11, further comprising:
a content server adapted to gather promotions to upgrade and provide them to the mobile device;
wherein the mobile device is further adapted to display the promotions to the customer, receive customer selections and provide any costs to the point of sale device.

13. The club membership system of claim 11, wherein the linking module employs one of the group consisting of:
a Wi-Fi communication device, a near field communication device, a bar code reader, and a QR code reader.

14. The club membership system of claim 11, further comprising:
a content server adapted to gather membership promotions to provide to the customer.

15. The club membership system of claim 11, wherein the remote computing entity is a web server.

16. A club membership system adapted to update membership status comprising:
a mobile device running an App adapted to:
automatically make a connection to a specific remote computing entity;
display screens to a customer and receive the customer selections;
make an electronic payment;
a membership database having the current status of each membership;
a remote computing entity, connected to the linking module, adapted to:
receive the contact card and search the membership database and find a membership and its status related to a contact card;
provide screens requesting customer input and receive the customer's input in response to the screens;
receive customer input and update the membership database with the customer input; and
a point of sale (POS) device adapted to receive membership status, adjust costs based upon the membership status, add charges for any membership fees and upgrade fees; and
receive payment from the customer.

17. The club membership system of claim 16, further comprising:
a content server adapted to gather membership promotions to provide to the customer.

18. The club membership system of claim 16, wherein the mobile device employs one of the group consisting of:
a Wi-Fi communication device, a near field communication device, a bar code reader, and a QR code reader.

19. The club membership system of claim 16, wherein the remote computing entity is a web server.

20. The club membership system of claim 16, wherein the POS device is further adapted to accumulates cost savings between a cost that a non-member pays compared to that paid by a member and provides the cost savings to the mobile device to display to the customer.
